(19) United States
(12) Patent Application Publication
(10) Pub. No.: US 2014/0279565 A1
(43) Pub. Date: Sep. 18, 2014

(54) SYSTEM FOR SECURE AUTOMOTIVE IN-VEHICLE WIRELESS PAYMENTS

(71) Applicant: CIRQUE CORPORATION, Salt Lake City, UT (US)

(72) Inventors: Ethan Trump, Salt Lake City, UT (US); J. Douglas Moore, Salt Lake City, UT (US)

(73) Assignee: CIRQUE CORPORATION, Salt Lake City, UT (US)

(21) Appl. No.: 14/208,643

(22) Filed: Mar. 13, 2014

Related U.S. Application Data
(60) Provisional application No. 61/781,735, filed on Mar. 14, 2013.

(51) Int. Cl. G06Q 20/38; G06Q 20/40; G06Q 20/32

(52) U.S. Cl. CPC G06Q 20/3821; G06Q 20/3227; G06Q 20/4012
USPC 705/72; 705/44

(57) ABSTRACT

A system and method for providing a touch sensor disposed in a vehicle, wherein the touch sensor may be a portable device that is removable from the vehicle such as a tablet computer or it may be a built-in device, wherein the touch sensor may store account information in a secure element in order to make a secure payment by wirelessly communicating with a merchant terminal from within the vehicle in order to make a financial transaction without giving a physical credit or debit card to the merchant.

### BACKGROUND OF THE INVENTION

1. Field of the Invention

This invention relates generally to a secure transaction. More specifically, the invention is directed to a vehicle being equipped with a system including a touch sensor that makes it possible to perform secure financial transactions from the vehicle without having to provide a physical financial card to a merchant.

2. Description of Related Art

When discussing touch sensors, it is noted that there are several different designs for capacitance sensitive sensors. One of the existing touchpad designs that may be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 may be used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16. On other touchpad designs, there may be an array of drive and an array of sense electrodes instead of the single sense electrode.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24.

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

### BRIEF SUMMARY OF THE INVENTION

In a first embodiment, the present invention is a system and method for providing a touch sensor disposed in a vehicle, wherein the touch sensor may be a portable device that is removable from the vehicle such as a tablet computer or it may be a built-in device, wherein the touch sensor may store account information in a secure element in order to make a secure payment by wirelessly communicating with a merchant terminal from within the vehicle in order to make a financial transaction without giving a physical credit or debit card to the merchant.

The proliferation of portable electronic appliances such as mobile telephones, smart phones or tablet computers has made it desirable to be able to use a same or similar device stored in a vehicle in order to make secure payments in a financial transaction. It would be an advantage to be able to increase security when performing any sort of financial transaction using a vehicle equipped for making secure transactions.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

FIG. 2 is a diagram of a first embodiment for making a secure payment from a vehicle equipped with a secure element for securely storing and transmitting financial information.

FIG. 3 is a block diagram for a second embodiment for making secure transactions from a vehicle to a merchant.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document includes any capacitive touch sensor device, including touchpads, touch screens and touch panels, and includes proximity and touch sensing capabilities.

The present invention is directed to the concept of turning a vehicle that is equipped with a touch sensor to now be capable of making a secure payment by emulating a credit card using the touch sensor.

A consumer may use a smart card that functions as a credit card to make a payment by bringing the smart card close enough to a smart card reader that is part of a point of sale (POS) terminal. The POS terminal reads the account information, and communicates with financial institutions in order to perform a financial transaction.

The present invention is directed to providing a touch sensor in a vehicle that includes all the components necessary to make a secure transaction possible from the vehicle without ever having to provide a physical credit card to a merchant. In other words, the touch sensor disposed in the vehicle may function as a smart card. The terms “credit card”, “smart card”, “debit card”, “gift card”, “financial card” and “ATM card” may all be used interchangeably throughout this document.

This document may use the term “mobile payment” to refer to a touch screen functioning as a credit card for making a payment. The touch sensor may be a built-in device within the vehicle such as in a vehicle's infotainment system that may be accessed on a built-in display, or it may be a removable or mobile device that may be removed from the vehicle when needed. For example, the mobile device may be a mobile telephone, smart phone or tablet computer that may be capable of communicating with the vehicle. Thus, the touch sensor may include a display and may be as small as a mobile phone or as large as a tablet computer.

An aspect of the present invention that enables mobile payments is a concept referred to as a secure element. A secure element includes at least four different embodiments, but should not be considered as limited to these four. These embodiments of a secure element include a Subscriber Identity Module (SIM) which is also known as a Universal Integrated Circuit Card (UICC). The SIM/UICC may be a SIM or memory card that may be disposed inside the touch sensor or be associated with the touch sensor. Another embodiment may be an embedded SIM card that may be soldered into the smart phone or the tablet computer. Another embodiment may be a micro SD card that fits into a micro SD slot in the smart phone or the tablet computer. Another embodiment may be a secure CPU in which the secure element is embedded inside a CPU that is in turn embedded within a smart phone or a tablet computer, or embedded within a vehicle's infotainment system.

The present invention uses any form of the secure elements described, or another form factor for the secure element that may be disposed in a mobile consumer device that may be installed in a vehicle, and then uses the secure element to enable the mobile device to perform mobile payments.

FIG. 2 is directed to making a mobile payment using a smart phone, a tablet computer or other touch sensor 30 that is disposed within a vehicle, either permanently or temporarily. The touch sensor 30 may include a wireless communication system 32 that enables communication to another device outside the vehicle that may also communicate using a wireless communication system. The wireless communication systems include a vehicle wireless communication system and a merchant wireless communication system.

The wireless communication system 32 used by the touch sensor 30 may be comprised of near field communication (NFC) technology, Bluetooth technology, radio frequency technology, infrared technology or any other wireless communication technology that enables communication between the touch sensor 30 and a payment system disposed outside of the vehicle.

The touch sensor 30 may be used to perform a financial transaction by storing financial account information. This information may be stored in a manner that is similar to a smart card that may function as a credit card, debit card, ATM card or any other financial institution card that enables payment. The touch sensor 30 may either store the account information in a separate memory that is dedicated to that purpose, or store it in memory that may be used by the touch sensor for other functions as well.

The wireless communication system 32 in the touch sensor 30 may be used to transmit financial account information to a secure payment terminal outside the vehicle.

In FIG. 2, a vehicle may approach a secure payment terminal or merchant terminal 34. The touch sensor 30 in the vehicle and the merchant terminal 34 may communicate using the wireless communication technology 32. Communication may be prompted by the touch sensor 30 or by the merchant terminal 34.

The merchant terminal 34 receives the secure element data from the touch sensor 30 in the vehicle and sends it to a financial institution that may be referred to as a host 36. The host 36 may provide authorization to the merchant terminal 34 for the secure financial transaction. This authorization may then be transmitted to the touch sensor 30 in the vehicle.

In another aspect of the invention, this embodiment describes a system that may enable secure storage of payment credentials or other financial data and secure payment authorization in a vehicle. The system may be comprised of a touch sensor 30 that is not secure or a secure touch sensor with integrated contactless reader. Alternatively, the contactless reader may be located external to the touch sensor 30. The touch sensor 30 may be secured so that information on the touch sensor may not be intercepted by third parties or malicious software.

In an alternative embodiment the system includes a contact card reader.

The system may include a secure element (SE) that is bound to the touch sensor 30 and a contactless/contact card reader for receiving or transmitting payment credentials.

Finally, the system may include a wireless communication system 32 for interacting with external merchant terminals 34, payment processing devices, or with networks.

The system may allow a vehicle to store payment or identity credentials such as credit card PIN or EMV card data in a secure manner in the secure element 38 in the vehicle. Loading of payment credentials may be manual, via a secure touch sensor in the case of a credit card account number, or via the contactless or contact card interfaces which may also be a part of the touch sensor 30. Once the payment credentials are stored in the secure element 38, there is no need to re-enter them unless the credentials change or the vehicle is sold.

FIG. 3 is a more detailed view of components of a vehicle payment system in a second embodiment. The vehicle 40 may have a wireless communication system 32 including an antenna 42. The wireless communication system 32 communicates with a touch controller 44. The touch controller 44 is secure and includes the secure element 38. The touch controller 44 also communicates with the touch sensor 30. The touch sensor 30 may also be secure device. The touch sensor 30 may include a contactless antenna 46 such as for NFC or Bluetooth communications. The contactless antenna may communicate with a contactless integrated circuit 48.

The touch controller 44 may also communicate with an optional contactless card reader 50 that is separate from the contactless antenna 46. Finally, the touch controller 44 may also communicate with a vehicle CPU 52 which may include a vehicle display 54.

The vehicle 40 may communicate via the wireless communication system 32 with the merchant 60. The merchant 60 may include a wireless communication system 62 and antenna 64. The merchant's wireless communication system 62 in turn is communicating with the point-of-sale terminal 66.

In practice, the touch sensor 30 may wirelessly interact with the merchant terminal. The merchant terminal may be disposed within or be part of a point-of-sale (POS) terminal that may be located at any business. For example a drive-through restaurant, a dry cleaner, a coffee shop and a tool booth are just a few examples of drive-through services that may use the present invention. Other services are not drive-through but provide services such as a fuel pump or a parking meter. In addition, the in-vehicle touch sensor 30 may be used for food ordering, parking time selection and other options.

In order to unlock the payment credentials and authorize payment the driver (or an authorized passenger) may be required to input a PIN number on the touch sensor or on a secure touch screen in order to unlock the secure element 38.

An example of the embodiment of the present invention in operation is as follows. A vehicle comes into proximity with a compatible merchant terminal 34. A driver may enter information via a touch system as applicable such as ordering food from a restaurant menu. An in-vehicle display may show a purchase total and then prompt for payment. The driver may enter a PIN number via the touch sensor 30 in order to unlock payment credentials. The driver may select pre-saved payment credentials and may then authorize payment. The payment may be wirelessly transmitted to the merchant terminal 34. The merchant terminal 34 may communicate with a host system 36 such as a financial institution. Authorization for the transaction may be received from the host 36 at the merchant terminal 34. The merchant terminal may then wirelessly transmit a receipt or transaction information to the touch sensor 30. The transaction information may then be displayed on an in-vehicle display associated with the touch sensor 30. The user in the vehicle may then be given the option to send the financial transaction to an email, or request a printed receipt form the merchant.

A credit card or other physical card may have an account number and a code that verifies that the card is in the hands of the person making the purchase. Advantageously, the physical card would not have to be given to the merchant in order to complete the financial transaction, thereby eliminating the possibility that a dishonest merchant or employee might obtain access to the credit card information. Furthermore, by requiring PIN validation to access the payment credentials and authorize payment, it is impossible for an unauthorized driver to make purchases without that information, and the owner's credit card data is protected in the case of theft of the touch screen or the vehicle.

Merchant loyalty and couponing may also be supported by this system.

Additional functionality made possible by this invention may be for the vehicle display to utilize PCI approved point-to-point encryption methods to accept PIN debit transactions using the vehicle touch sensor 30 as the PIN Entry Device.

Another example of use of the system is making secure Internet purchasing and conducting online banking via the vehicle display using the saved payment or identity credentials.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for making a secure financial transaction from a vehicle without giving a merchant a physical financial card, said method comprising:
providing a touch sensor that includes a secure element for securely storing payment credentials, a vehicle wireless communication system, and a vehicle for holding the touch sensor;
providing a merchant terminal including a merchant wireless communications system;
transmitting the payment credentials from the touch sensor to the merchant terminal using the vehicle wireless communication system and the merchant wireless communication system without giving a merchant a physical financial card; and
communicating with a financial institution from the merchant terminal in order to perform a secure financial transaction using the payment credentials.

2. The method as defined in claim 1 wherein the method further comprises selecting the financial card from the group of financial cards comprised of a smart card, a credit card, a debit card, an ATM card and a gift card.

3. The method as defined in claim 2 wherein the method further comprises providing a display in the vehicle for displaying information regarding the secure financial transaction.

4. The method as defined in claim 3 wherein the method further comprises selecting the vehicle wireless communication system and the merchant wireless communication system from the group of wireless communication systems comprised of near field communication (NFC) technology, Bluetooth technology, radio frequency technology and infrared technology.

5. The method as defined in claim 1 wherein the method further comprises making the touch sensor a removable touch sensor that can be removed from the vehicle.

6. The method as defined in claim 3 wherein the method further comprises combining the touch sensor and the display in an infotainment system within the vehicle.

7. The method as defined in claim 1 wherein the method further comprises disposing the touch sensor in a mobile device.

8. The method as defined in claim 7 wherein the method further comprises selecting the mobile device from the group of mobile devices comprised of a mobile phone, a smart phone and a tablet computer.

9. The method as defined in claim 1 wherein the method further comprises selecting the secure element from the group of secure elements comprised of a Subscriber Identity Module (SIM), a Universal Integrated Circuit Card (UICC), a memory card, an embedded SIM card that may be soldered a mobile device, a micro SD card, and a secure CPU.

10. The method as defined in claim 1 wherein the method further comprises providing a contactless card reader or a contact card reader as part of the touch sensor to thereby enable the touch sensor to receive payment credentials from a smart card.

11. The method as defined in claim 1 wherein the method further comprises providing a secure touch controller as part of the touch sensor to thereby enable the secure touch controller to store the secure element.

12. The method as defined in claim 1 wherein the method further comprises selecting the merchant terminal from the group of merchant terminals comprised of a point-of-sale terminal, a fuel pump, a tool booth, and a parking meter.

13. The method as defined in claim 1 wherein the method further comprises providing a secure touch sensor so that a personal identification number (PIN) may be entered in order to unlock the secure element.

14. The method as defined in claim 1 wherein the merchant terminal transmits transaction information to the touch sensor after authorization is received by the merchant terminal.

15. A system for making a secure financial transaction from a vehicle without giving a merchant a physical financial card, said system comprised of:
a touch sensor;
a secure element disposed in the touch sensor for storing payment credentials;
a vehicle wireless communication system;
a vehicle for holding the touch sensor and the vehicle wireless communication system;
a merchant terminal;
a merchant wireless communications system;
wherein the payment credentials are transmitted from the touch sensor to the merchant terminal without giving a merchant a physical financial card, and wherein the merchant terminal communicates with a financial institution from the merchant terminal in order to perform a secure financial transaction using the payment credentials.

16. The system as defined in claim 15 wherein the system is further comprised of a display disposed in the vehicle for displaying information regarding the secure financial transaction.

17. The system as defined in claim 16 wherein the system is further comprised of an infotainment system within the vehicle for housing the display and the touch sensor.

18. The method as defined in claim 15 wherein the method further comprises disposing the touch sensor in a mobile device.

19. The system as defined in claim 15 wherein the system is further comprised of selecting the secure element from the group of secure elements comprised of a Subscriber Identity Module (SIM), a Universal Integrated Circuit Card (UICC), a memory card, an embedded SIM card that may be soldered a mobile device, a micro SD card, and a secure CPU.

20. The system as defined in claim 15 wherein the system is further comprised of a contactless card reader or a contact card reader as part of the touch sensor to thereby enable the touch sensor to receive payment credentials from a smart card.

21. The system as defined in claim 15 wherein the system is further comprised of selecting the merchant terminal from the group of merchant terminals comprised of a point-of-sale terminal, a fuel pump, a tool booth, and a parking meter.
